(19) United States
(12) Patent Application Publication
(10) Pub. No.: US 2020/0034769 A1
(43) Pub. Date: Jan. 30, 2020

(54) SYSTEMS AND METHODS FOR CROWDSOURCED DELIVERY

(71) Applicant: Walmart Apollo, LLC, Bentonville, AR (US)

(72) Inventors: Benjamin D. Enssle, Bella Vista, AR (US); Jesse L. Eaton, Springdale, AR (US); Cristy C. Brooks, Cassville, MO (US); David Blair Brightwell, Bentonville, AR (US); Greg A. Bryan, Centerton, AR (US); Jeffrey Kerbs, Bentonville, AR (US); Ryan D. Kee, Bentonville, AR (US)

(21) Appl. No.: 16/524,776

(22) Filed: Jul. 29, 2019

Related U.S. Application Data
(60) Provisional application No. 62/711,342, filed on Jul. 27, 2018.

(51) Int. Cl. G06Q 10/06; G06F 16/955; G06Q 10/08; G06Q 20/10; G06Q 30/00; G06Q 50/00; G06T 11/00

(52) U.S. Cl. CPC G06Q 10/06315; G06F 16/955; G06Q 10/087; G06Q 20/10; G06F 3/0482; G06Q 30/018; G06Q 50/01; G06T 11/00; G06Q 10/063114

(57) ABSTRACT

In some embodiments, apparatuses and methods are provided herein useful to providing crowdsourced delivery. In some embodiments, a system for providing crowdsourced delivery comprises a database, a mobile device configured to receive user information for a user, present a list including delivery tasks, receive selection of one of the delivery tasks, capture an image of a cargo area of the user's vehicle, generate an augmented reality representation of the product within the cargo area of the user's vehicle, and present the augmented reality representation of the product within the cargo area of the user's vehicle, and a control circuit configured to register the user, determine that one of the plurality of retail facilities needs a product, determine that one of the plurality of distribution centers possesses the product, generate a delivery task for the product, transmit an indication of the delivery task, generate an identifier, and transmit the identifier.

### CROSS-REFERENCE TO RELATED APPLICATION

This application claims the benefit of U.S. Provisional Application No. 62/711,342, filed Jul. 27, 2018, which is incorporated by reference in its entirety herein.

### TECHNICAL FIELD

This invention relates generally to delivery of products and, more specifically, crowdsourced delivery of products.

### BACKGROUND

Ensuring that a retail facility has sufficient stock of a product is important for both customer satisfaction and retailer profits. For example, if a retail facility does not have a product on hand, a customer may be frustrated or disappointed that he or she cannot purchase the product. Additionally, because the customer cannot purchase the product, the retailer loses a sale of the product, and possibly other products that the customer may have purchased. While intricate supply chains exist that attempt to maintain sufficient stock of all products at a retail facility, these supply chains are typically based on regular delivery schedules (e.g., a few times a week, once a week, a few times a month, once a month, etc.). If the retail facility sells all of a given product in between regularly scheduled deliveries, a typical supply chain will not be able to replenish the retail facility's stock until the next regularly scheduled delivery. Consequently, a need exists for additional or alternative mechanisms by which stock can be replenished at a retail facility.

### BRIEF DESCRIPTION OF THE DRAWINGS

Disclosed herein are embodiments of systems, apparatuses and methods pertaining to providing crowdsourced delivery. This description includes drawings, wherein:

FIG. 1A depicts a mobile device 102 presenting a list of delivery tasks, according to some embodiments;

FIG. 1B depicts a mobile device 112 presenting an augmented reality representation 116 of a product within the cargo area of a user's vehicle, according to some embodiments;

FIG. 2 is a block diagram of a system for providing crowdsourced delivery, according to some embodiments; and

FIG. 3 is a flow chart including example operations for providing crowdsourced delivery, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to providing crowdsourced delivery. In some embodiments, a system for providing crowdsourced delivery comprises a database, wherein the database includes inventory data for a plurality of retail facilities, item files for a plurality of products, and inventory data for a plurality of distribution centers, a mobile device, wherein the mobile device includes a user input device, wherein the mobile device is configured to receive, via the user input device, user information for a user, present via the display device, a list, wherein the list includes a plurality of delivery tasks, receive via the user input device, selection of one of the plurality of delivery tasks, capture, via a camera of the mobile device, an image of a cargo area of the user's vehicle, generate, based on the image of the cargo area of the user's vehicle and an augmented reality presentation of the product, an augmented reality representation of the product within the cargo area of the user's vehicle, wherein the augmented reality representation of the product within the cargo area of the user's vehicle aids the user in determining whether the user can accommodate the product, and present, via the display device, the augmented reality representation of the product within the cargo area of the user's vehicle, and a control circuit, wherein the control circuit is communicatively coupled to the database and the mobile device, and wherein the control circuit is configured to register, based on the user information for the user, the user, determine, based on the inventory data for a plurality of retail facilities, that one of the plurality of retail facilities needs a product, determine based on the inventory data for a plurality of distribution centers, that one of the plurality of distribution centers possesses the product, generate, for inclusion in the list, a delivery task for the product, transmit, to the mobile device, an indication of the delivery task for the product, wherein the indication of the delivery task for the product includes the augmented reality presentation of the product, and wherein the augmented reality presentation of the product is based on the item files for a plurality of products, generate, in response to selection of the one of the plurality of delivery tasks, an identifier, wherein the identifier indicates the user and the one of the plurality of delivery tasks, and transmit, to the mobile device, the identifier.

As previously discussed, a typical supply chain will replenish a retail facility's stock based on regularly scheduled deliveries. For example, a retail facility may receive a shipment every Friday. Typically, the products, and quantity of products, included in a delivery are based on a predicted need and/or on past sales data. However, because of the delays between deliveries, a retail facility may be left without sufficient stock of a product. Continuing the example above, if a retail facility sells all of its stock of Product X on a Monday, the retail facility will not receive another delivery in which its stock of Product X can be delivered until the following Friday. This may result in a number of lost sales of the product, and other products, before the next delivery on Friday and disappointed or frustrated customers. Embodiments of the inventive subject matter seek to overcome these problems with systems, methods, and apparatuses that utilize crowdsourced delivery. In some embodiments, the crowdsourced delivery can augment regularly scheduled deliveries. Additionally, the crowdsourced delivery can be passed on real-time, or near real-time, data.

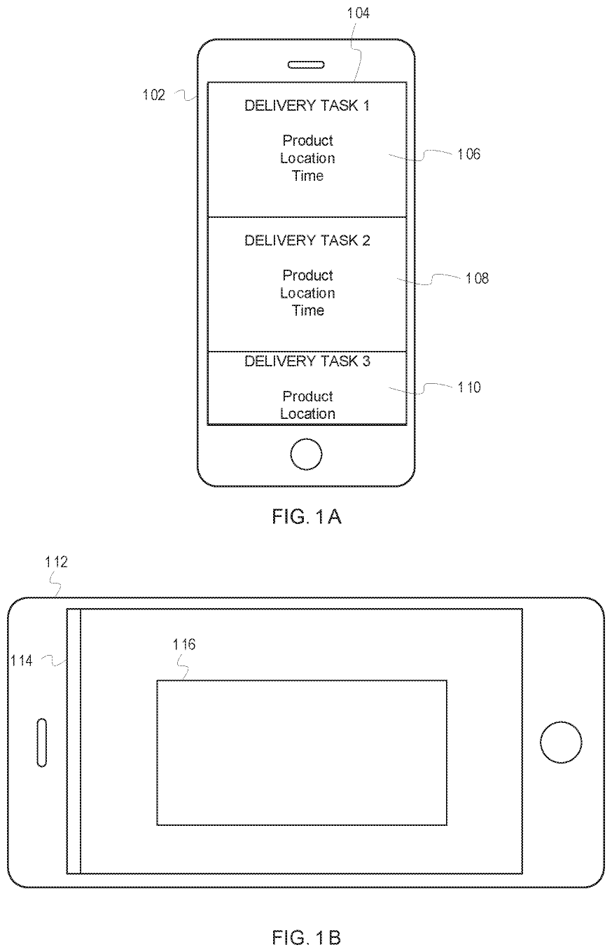

In one form, the crowdsourced delivery system is application-based (i.e., app-based). In such embodiments, the application (“app”) can present a list of delivery tasks which users can browse and select. The delivery tasks include details about the delivery (e.g., products included in the delivery, pickup location(s), drop off location(s), etc.). Additionally, in some embodiments, the app is capable of providing the user with an augmented reality representation of the product in a cargo area of the user's vehicle. Such augmented reality representation of the product in the cargo area of the user's vehicle may aid the user in determining whether he or she is able to accommodate the product and accept the delivery task. The discussion of FIGS. 1A and 1B provide background information regarding such a system.

FIG. 1A depicts a mobile device 102 presenting a list of delivery tasks, according to some embodiments. The mobile device 102 includes a display device 104. In some embodiments, as depicted in FIG. 1A, the display device 104 can also be a user input device (i.e., the display device 104 is a touchscreen). In other embodiments, the mobile device 102 may include one or more dedicated user input devices, such as keyboards, input pads, mice, joysticks, etc. Additionally, although FIG. 1A depicts a mobile device 102 as presenting the list of delivery tasks, any suitable device can be used to present the delivery tasks (e.g., a laptop computer, a desktop computer, a tablet computer, a personal digital assistant (PDA), etc.).

As depicted in FIG. 1A, the mobile device 102 is presenting three delivery tasks: a first delivery task 106, a second delivery task 108, and a third delivery task 110. Each of the delivery tasks includes information about the delivery task. For example, a delivery task may include an indication of products included in the delivery, pickup location(s), drop off location(s), etc. In some embodiments, the selection of a delivery task takes the user to a new presentation (e.g., a new screen), with expanded or additional information for the delivery task. Additionally, in some embodiments, compensation for completion of the delivery task can be presented in concert with the delivery task on the mobile device 102.

The system determines the delivery tasks based on inventory data for retail facilities and inventory data for distribution centers. For example, if the inventory data for Retail Facility X indicates that Retail Facility X is in need of additional ones of Product Y, the system determines a distribution center from which stock of Product Y can be delivered. This determination can be as simple as determining that a distribution center has stock of Product Y or can be more complex. For example, the determination of from which distribution center Product Y should be retrieved can be based on stock levels at multiple distribution centers, planned shipments from multiple distribution centers, other retail facilities to which Product Y will be supplied from multiple distribution centers, expected deliveries at distribution centers, and projected sales of Product Y at other retail facilities. In some embodiments, the system can create multiple delivery tasks with products originating from multiple distribution centers. For example, if Distribution Center 1, Distribution Center 2, and Distribution Center 3 each have stock of Product Y, but Retail Facility X's need for Product Y is too high to be met by a single distribution center (e.g., none of the distribution centers have sufficient stock of Product Y or sufficient excess stock of Product Y), the system can generate delivery tasks to receive Product Y from Distribution Center 1, Distribution Center 2, and Distribution Center 3 to be delivered at Retail Facility X.

In an app-based system, the user can register to become eligible to participate in the crowdsourced delivery. Such registration may require the user to submit user information (e.g., name, address, driver's license number, home address, etc.). Once registered, the user is able to view available delivery tasks. In some embodiments, users may only see a portion of available delivery tasks. For example, a user may only be able to see delivery tasks near the user's home address, work address, current location, etc. That is, the system may determine, based on any relevant factors, which delivery tasks should be presented to a user and cause the mobile device 102 to present only those delivery tasks. The factors used to determine which delivery tasks to present can be based on locations (e.g., the user's locations, the user's planned route, the user's typical routes, etc.), a vehicle utilized by the user (e.g., size or type of vehicle), timing requirements of the delivery task, a user's rating (e.g., based on previous performance), information about the user (e.g., a driving record, criminal record, or other such background check), etc.

Upon selection of a delivery task, the delivery task is assigned to the user. For example, the user can select the delivery task via the mobile device 102. Once assigned to the user, an entry is created indicating that the user is going to perform the selected delivery task. In some embodiments, the user is provided with an identifier, such as human-readable and/or machine-readable code (e.g., a barcode, QR code, alphanumeric code, etc.). In such embodiments, the user can present the identifier upon arrival at the distribution center. The presentation of the identifier can act as a security and error mitigation feature to ensure that the correct user is picking up the product and/or that the correct product is retrieved. Additionally, in some embodiments, the user can again present the identifier (or a new identifier generated after pickup) at the retail facility at the time of delivery. Such features may be used to confirm that the delivery has been completed.

In some embodiments, the system can utilize augmented reality technology to aid the user in selecting a delivery task. The discussion of FIG. 1B provides additional detail regarding such embodiments.

FIG. 1B depicts a mobile device 112 presenting an augmented reality representation 116 of a product within the cargo area of a user's vehicle, according to some embodiments. The mobile device 112 can present, before or after selection of a delivery task, an augmented reality representation 116 of the product within the cargo area of the user's vehicle. The augmented reality representation 116 can aid the user in determining if he or she can accommodate the delivery. The mobile device 112, for example via a camera, can capture an image of the cargo area of the user's vehicle. In some embodiments, the user is first instructed to place a known marker (i.e., any item of known size) in the cargo area of his or her vehicle. The system then generates, based on an augmented reality presentation of the product, the augmented reality representation 116 of the product within the cargo area of the user's vehicle. The augmented reality presentation of the product can be based on an item file for the product. The item file can include dimensional and/or weight information for the product. In some embodiments, item files for products are stored in a database and the system accesses the database to gather the dimensional and/or weight information for the product.

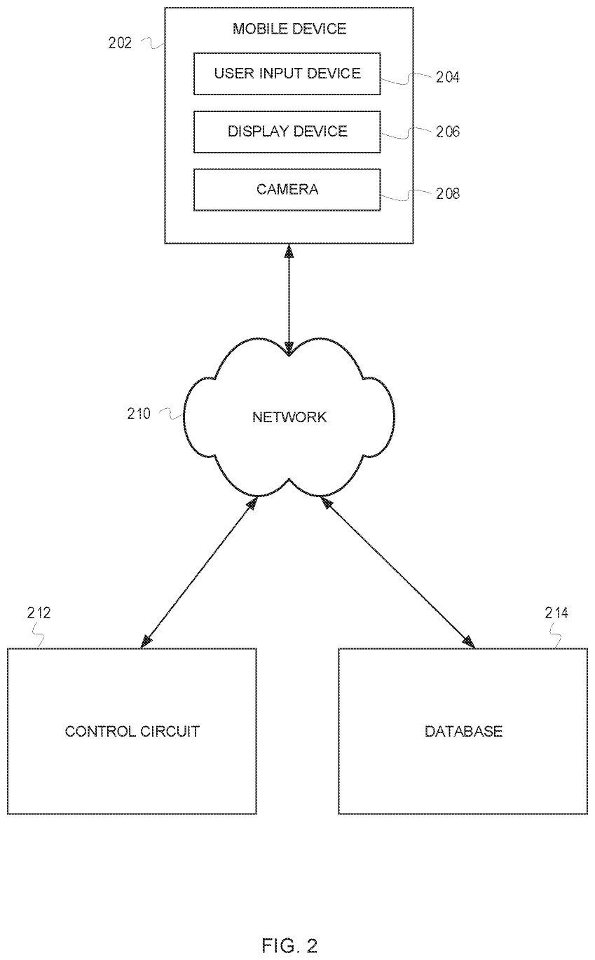

While the discussion of FIGS. 1A and 1B provides background information regarding a system for providing crowdsourced delivery, the discussion of FIG. 2 provides additional information regarding such a system.

FIG. 2 is a block diagram of a system for providing crowdsourced delivery, according to some embodiments. The system includes a mobile device 202, a network 210, a control circuit 212, and a database 214. The network 210 can be any suitable network over which the components of the system can communicate (e.g., a wide area network, such as the Internet).

The mobile device 202 includes a user input device 204, a display device 206, and a camera 208. The user input device 204 allows the user to input data, such as user information, and make selections, such as selections of delivery tasks. The display device 206 is configured to present data, such as a list of delivery tasks, as well as present augmented reality displays, such as an augmented reality representation of a product within the cargo area of the user's vehicle. The camera 208 is configured to capture images, for example, of the cargo area of the user's vehicle. In some embodiments, the mobile device 202 uses augmented reality presentations for products and images captured by the camera 208 to generate an augmented reality representation of products within the cargo area of the user's vehicle. For example, the augmented reality representation of a product within the cargo area of the user's vehicle can include the image of the cargo area of the user's vehicle superimposed with an image of the product. The segmented reality representation of the product within the cargo area of the user's vehicle can be static (i.e., a still image) or dynamic (e.g., a real-time, or near real-time, video feed of the augmented reality representation of the product within the cargo area of the user's vehicle). In either case, the user may be able to move the mobile device 202 with respect to his or her vehicle to see the product within his or vehicle from different angles. Additionally, in some embodiments, the user can manipulate the product within the cargo area of his or her vehicle (e.g., rotate, move, or otherwise reposition the product via the augmented reality representation of the product within the cargo area of the user's vehicle).

The database 214 can take any suitable form and can be remote from, or local to, the control circuit 212. The database 214 includes inventory data for a plurality of retail facilities, item files for a plurality of products, and inventory data for a plurality of distribution centers.

The control circuit 212 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 212 is configured (for example, by using corresponding programming as will be well understood by those skilled in the art) to carry out one or more of the steps, actions, and/or functions described herein.

By one optional approach the control circuit 212 operably couples to a memory. The memory may be integral to the control circuit 212 or can be physically discrete (in whole or in part) from the control circuit 212 as desired. This memory can also be local with respect to the control circuit 212 (where, for example, both share a common circuit board, chassis, power supply, and/or housing) or can be partially or wholly remote with respect to the control circuit 212 (where, for example, the memory is physically located in another facility, metropolitan area, or even country as compared to the control circuit 212).

This memory can serve, for example, to non-transitorily store the computer instructions that, when executed by the control circuit 212, cause the control circuit 212 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit 212 is configured to generate delivery tasks. The delivery tasks are based on which retail facility has a need for a product and which distribution center(s) possess the product. In some embodiments, the control circuit 212 accesses the database 214 to determine retail facility need and distribution center availability. For example, the control circuit 212 can access the inventory data for the retail facilities and the inventory data for the distribution centers to determine that a retail facility needs a product and from which distribution center the product should be delivered.

Upon generation of the delivery task, the control circuit 212 transmits an indication of the delivery task to the mobile device 202. For example, the control circuit 212 can transmit the indication of the delivery task to the mobile device 202 via the network 210. In some embodiments, the indication of the delivery task includes an augmented reality presentation of the product. The augmented reality presentation of the product is based on an item file for the product, which can also be stored in the database 214.

When a user selects a delivery task, the control circuit 212 generates an identifier. The identifier includes information about the delivery and an association between the delivery and the user that accepted the delivery task. The identifier can be any type of human- or machine-readable code. The control circuit 212 transmits the identifier to the mobile device 202. In some embodiments, the user scans, or otherwise inputs the identifier, at the distribution center and/or retail facility. For example, the distribution center and/or retail facility can include scanning devices configured to scan, or otherwise receive from the user and/or mobile device 202, the identifier. In such embodiments, the control circuit 212 can receive confirmations, as well as other information such as timestamp information, from the scanning devices. That is, the scanning devices can transmit indications to the control circuit 212 upon receipt of the identifier. Such scanning devices can be useful in embodiments in which the user is compensated upon completion of the delivery. For example, the control circuit 212 can facilitate payment to the user upon receipt of confirmation that the delivery task has been completed.

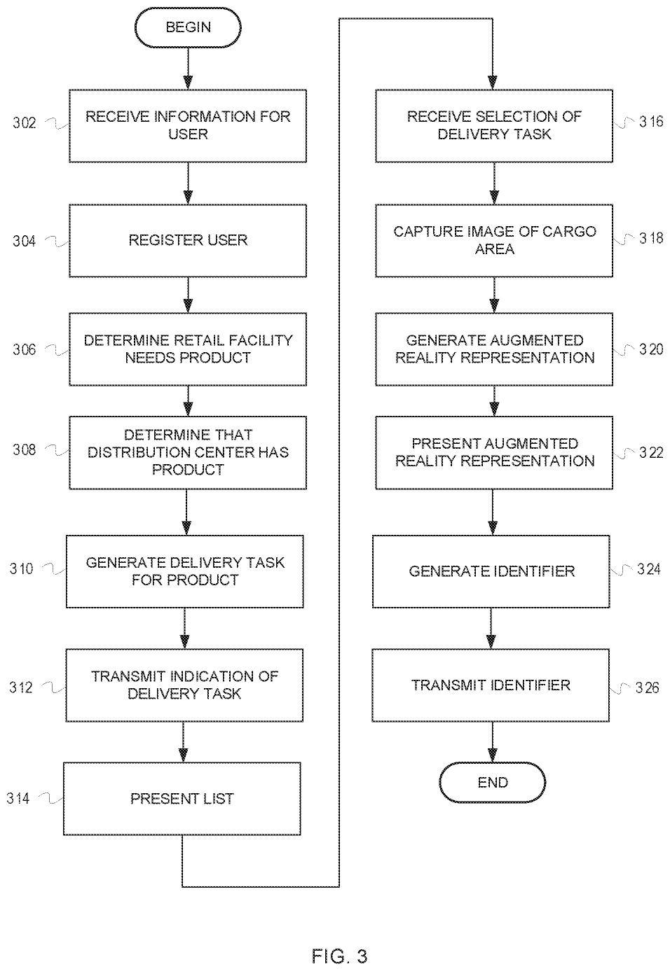

While the discussion of FIG. 2 provides additional details regarding a system for providing crowdsourced delivery, the discussion of FIG. 3 provides example operations for such a system.

FIG. 3 is a flow chart including example operations for providing crowdsourced delivery, according to some embodiments. The flow begins at block 302.

At block 302, information for a user is received. For example, a mobile device can receive the information for the user. The mobile device can receive the information for the user via a user input device. Alternatively, or additionally, the mobile device can receive the information for the user from a database or other centralized data repository. For example, the user can provide the mobile device, or a control circuit, with permission to access the user's information from a third-party source. The information for the user can include any suitable information, such as the user's name, age, location, planned trips, vehicle, preferences, compensation requirements, product requirements, etc. the flow continues at block 304.

At block 304, the user is registered. For example, a control circuit can register the user based on the user information. In some embodiments, the registration process can include a background check. The flow continues at block 306.

At block 306, it is determined that a retail facility needs a product. For example, the control circuit can determine that a retail facility needs a product. In some embodiments, retail facilities can communicate product need explicitly. For example, the retail facility can record an indication of a need for a product in a database. Additionally, or alternatively, the control circuit can determine an implicit need of a product when inventory levels for a product are below a threshold. In either case, the control circuit determines that the retail facility needs the product based on inventory data for the retail facility. The control circuit can determine that the retail facility needs the product based simply on the current stock of the retail facility and/or projected sales for the retail facility. In some embodiments, the projected sales for the retail facility can be based on past sales data and/or sales predictions varying from average based, for example, on upcoming events, sales, promotions, etc. The flow continues at block 308.

At block 308, it is determined that a distribution facility has the product. That is, it is determined that the distribution center possesses the product for which the retail facility has a need. For example, the control circuit can determine that the distribution facility has the product. The control circuit can determine that the distribution center has the product based on inventory data for the distribution center. In some embodiments, the control circuit will only determine that the distribution center possesses the product if the distribution center has excess stock of the product (i.e., additional ones of the product than are scheduled for a planned delivery to the retail facility and/or other retail facilities). Additionally, the control circuit can determine that multiple distribution centers possess the product. In such embodiments, the control circuit can select one or more of the distribution centers as the distribution center(s) from which the product should be delivered to the retail facility. The flow continues at block 310.

At block 310, a delivery task for the product is generated. For example, the control circuit can generate the delivery task for the product. The control circuit generates the delivery task for the product for inclusion in the list of delivery tasks to be presented via the mobile device. The delivery task for the product includes information for the delivery task, such as an indication of the product(s), a quantity of the product(s), a location of the distribution center(s) from which the product(s) is to be retrieved, a location of the retail facility or retail facilities at which the product(s) are to be delivered, timing requirements (if any) for the delivery task, restrictions for the delivery task (e.g., based on age restrictions, licenses, etc. required for the product(s), or any other desired information. The flow continues at block 312.

At block 312, an indication of the delivery task is transmitted. For example, the control circuit can transmit the indication of the delivery task to the mobile device. In some embodiments, the indication of the delivery task includes an augmented reality presentation of the product. In such embodiments, the augmented reality presentation of the product is based on an item file for the product. The item file for the product can be stored in a database. The item file for the product can include any relevant information, such as dimensional information for the product, weight information for the product, condition requirements for the product (e.g., temperature, humidity, orientation, etc.), etc. The flow continues at block 314.

At block 314, a list is presented. For example, the mobile device can present, via a display device, the list. The list includes the delivery tasks. In some embodiments, all users can view the entirety of the list (i.e., all delivery tasks). In other embodiments, the mobile device will only present specific delivery tasks to the user. For example, the control circuit may only transmit indications of specific delivery tasks to the mobile device and/or the mobile device can filter the delivery tasks and only present the specific delivery tasks. The delivery tasks that are presented can be based on the user (e.g., based on what types of delivery tasks the user is able to perform, based on the user's rating, etc.), locations (e.g., of the user, retail facility, distribution center), timing requirements, or any other suitable criteria. Additionally, the order of presentation of the delivery tasks can tailored to the user. For example, a user with a higher rating may be presented with higher value or more critical delivery tasks earlier in the list than another user. As another example, the delivery tasks can be sorted and presented based on the location of the user, the retail facility, and/or the location of the distribution center. Further, in some embodiments, the user can sort and/or filter the delivery tasks via sort and filter controls. The flow continues at block 316.

At block 316, a selection of a delivery task is received. For example, the mobile device can receive the selection of the delivery task via a user input device associated with the mobile device. The mobile device can transmit an indication of the selection of the delivery task to the control circuit. The flow continues at block 318.

At block 318, an image of the cargo area of the user's vehicle is captured. For example, the mobile device can capture the image of the cargo area of the user's vehicle via a camera associated with the mobile device. The cargo area of the user's vehicle can be any portion of the user's vehicle capable of accommodating a product (e.g., a trunk, frunk, rooftop or trailer hitch mounted carrier, seating area, etc.). The image of the cargo area of the user's vehicle is used to create an augmented reality representation of the product within the cargo area of the user's vehicle. In some embodiments, the image of the cargo area of the user's vehicle includes a marker. The marker can be any suitable object of which the size is known, can be derived, or can be entered. The marker can be an object that already exists within the cargo area of the user's vehicle or an object that is placed within the cargo area of the user's vehicle. The flow continues at block 320.

At block 320, an augmented reality representation of the product within the cargo area of the user's vehicle is generated. For example, the control circuit can generate the augmented reality representation of the product within the cargo area of the user's vehicle. Alternatively, the mobile device can generate the augmented reality representation of the product within the cargo area of the user's vehicle. In either case, the augmented reality representation of the product within the cargo area of the user's vehicle is based on the image of the cargo area of the user's vehicle and the augmented reality presentation of the product. The augmented reality representation of the product within the cargo area of the user's vehicle depicts the augmented reality presentation of the product superimposed with the image of the cargo area of the user's vehicle. The flow continues at block 322.

At block 322, the augmented reality representation of the product within the cargo area of the user's vehicle is presented. For example, the mobile device can present the augmented reality representation of the product within the cargo area of the user's vehicle via a display device. The mobile device can present the augmented reality representation of the product within the cargo area of the user's vehicle in a static or dynamic manner. Additionally, in some embodiments, the mobile device allows the user to alter the augmented reality representation of the product within the cargo area of the user's vehicle. For example, if the user would like to accept multiple deliveries of a portion of a delivery, the user can alter the augmented reality representation of the product within the cargo area of the user's vehicle by removing and/or adding products from different delivery tasks or the same delivery task. The flow continues at block 324.

At block 324, and identifier is generated. For example, the control circuit can generate the identifier. The identifier can be any of any suitable type. The identifier includes or references information about the delivery task as well as an association between the user and the delivery task. The flow continues at block 326.

At block 326, the identifier is transmitted. For example, the control circuit can transmit the identifier to the mobile device. The user can utilize the identifier, presented via the mobile device, during the performance of the delivery task. For example, the user can scan or otherwise enter the identifier upon receipt and/or delivery of the products.

In some embodiments, a system for providing crowdsourced delivery comprises a database, wherein the database includes inventory data for a plurality of retail facilities, item files for a plurality of products, and inventory data for a plurality of distribution centers, a mobile device, wherein the mobile device includes a user input device, wherein the mobile device is configured to receive, via the user input device, user information for a user, present via the display device, a list, wherein the list includes a plurality of delivery tasks, receive via the user input device, selection of one of the plurality of delivery tasks, capture, via a camera of the mobile device, an image of a cargo area of the user's vehicle, generate, based on the image of the cargo area of the user's vehicle and an augmented reality presentation of the product, an augmented reality representation of the product within the cargo area of the user's vehicle, wherein the augmented reality representation of the product within the cargo area of the user's vehicle aids the user in determining whether the user can accommodate the product, and present, via the display device, the augmented reality representation of the product within the cargo area of the user's vehicle, and a control circuit, wherein the control circuit is communicatively coupled to the database and the mobile device, and wherein the control circuit is configured to register, based on the user information for the user, the user, determine, based on the inventory data for a plurality of retail facilities, that one of the plurality of retail facilities needs a product, determine based on the inventory data for a plurality of distribution centers, that one of the plurality of distribution centers possesses the product, generate, for inclusion in the list, a delivery task for the product, transmit, to the mobile device, an indication of the delivery task for the product, wherein the indication of the delivery task for the product includes the augmented reality presentation of the product, and wherein the augmented reality presentation of the product is based on the item files for a plurality of products, generate, in response to selection of the one of the plurality of delivery tasks, an identifier, wherein the identifier indicates the user and the one of the plurality of delivery tasks, and transmit, to the mobile device, the identifier.

In some embodiments, an apparatus and a corresponding method performed by the apparatus comprises receiving, at a mobile device via a user input device, user information for a user, registering, by a control circuit based on the user information for the user, the user, determining, by the control circuit based on inventory data for a plurality of retail facilities in a database, that one of the plurality of retail facilities needs a product, determining, by the control circuit based on inventory data for a plurality of distribution centers in the database, that one of the plurality of distribution centers possesses the product, generating, by the control circuit for inclusion in a list, a delivery task for the product, transmitting, by the control circuit to the mobile device, an indication of the delivery task for the product, wherein the indication of the delivery task for the product includes an augmented reality presentation of the product, and wherein the augmented reality presentation of the product is based on an item file in the database, presenting via a display device of the mobile device, the list, wherein the list includes a plurality of delivery tasks, wherein the plurality of delivery tasks includes the delivery task for the product, receiving, via the user input device of the mobile device, selection of the delivery ask for the product, capturing, via a camera of the mobile device, an image of a cargo area of the user's vehicle, generating, based on the image of the cargo area of the user's vehicle and the augmented reality presentation of the product, an augmented reality representation of the product within the cargo area of the user's vehicle, wherein the augmented reality representation of the product within the cargo area of the user's vehicle aids the user in determining whether the user can accommodate the product, presenting, via the display device of the mobile device, the augmented reality representation of the product within the cargo area of the user's vehicle, generating, by the control circuit in response to the selection of the delivery task for the product, an identifier, wherein the identifier indicates the user and the delivery task for the product, and transmitting, by the control circuit to the mobile device, the identifier.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing crowdsourced delivery, the system comprising:
a database, wherein the database includes inventory data for a plurality of retail facilities, item files for a plurality of products, and inventory data for a plurality of distribution centers;
a mobile device, wherein the mobile device includes a user input device and a display device, wherein the mobile device is configured to:
receive, via the user input device, user information for a user;
present, via the display device, a list, wherein the list includes a plurality of delivery tasks;
receive, via the user input device, selection of one of the plurality of delivery tasks;
capture, via a camera of the mobile device, an image of a cargo area of the user's vehicle;
generate, based on the image of the cargo area of the user's vehicle and an augmented reality presentation of the product, an augmented reality representation of the product within the cargo area of the user's vehicle, wherein the augmented reality representation of the product within the cargo area of the user's vehicle aids the user in determining whether the user can accommodate the product; and
present, via the display device, the augmented reality representation of the product within the cargo area of the user's vehicle; and
a control circuit, wherein the control circuit is communicatively coupled to the database and the mobile device, and wherein the control circuit is configured to:
register, based on the user information for the user, the user;
determine, based on inventory data for a plurality of retail facilities, that one of the plurality of retail facilities needs a product;
determine, based on the inventory data for a plurality of distribution centers, that one of the plurality of distribution centers possesses the product;
generate, for inclusion in the list, a delivery task for the product;
transmit, to the mobile device, an indication of the delivery task for the product, wherein the indication of the delivery task for the product includes the augmented reality presentation of the product, and wherein the augmented reality presentation of the product is based on the item files for a plurality of products;
generate, in response to selection of the one of the plurality of delivery tasks, an identifier, wherein the identifier indicates the user and the one of the plurality of delivery tasks; and
transmit, to the mobile device, the identifier.

2. The system of claim 1, further comprising:
a scanning device, wherein the scanning device is located at the one of the plurality of retail facilities, and wherein the scanning device is configured to scan the identifier; and
wherein the control circuit is further configured to receive an indication that the identifier has been scanned by the scanning device.

3. The system of claim 1, wherein the mobile device is further is further configured to:
capture, via the camera of the mobile device, an image of a marker, wherein the image of the marker is used for scale in generating the augmented reality representation of the product within the cargo area of the user's vehicle.

4. The system of claim 1, wherein multiple of the plurality of distribution centers possesses the product, and wherein the control circuit is further configured to:
select, from the multiple of the plurality of distribution facilities, the one of the plurality of distribution facilities.

5. The system of claim 4, wherein the control circuit selects the one of plurality of distribution centers based on one or more of a location of each of the multiple of the distribution centers, a location of the user, a quantity of the product at each of the multiple distribution centers, planned shipments from each of the multiple distribution centers, and a location of the one of the plurality of retail facilities.

6. The system of claim 1, wherein the control circuit is further configured to:
facilitate payment to the user.

7. The system of claim 6, wherein the control circuit is configured to facilitate payment to the user after receipt of confirmation that the delivery task for the product has been completed.

8. The system of claim 1, wherein the list of delivery tasks includes one or more of an indication of a product associated with each of the delivery tasks, a location of a distribution center, a location of a retail facility, a payment associated with each of the delivery tasks, and timing requirements associated with each of the delivery tasks.

9. The system of claim 1, wherein the registration of the user includes a background check of the user.

10. A method for providing crowdsourced delivery, the method comprising:
receiving, at a mobile device via a user input device, user information for a user;
registering, by a control circuit based on the user information for the user, the user;
determining, by the control circuit based on inventory data for a plurality of retail facilities in a database, that one of the plurality of retail facilities needs a product;
determining, by the control circuit based on inventory data for a plurality of distribution centers in the database, that one of the plurality of distribution centers possesses the product;
generating, by the control circuit for inclusion in a list, a delivery task for the product;
transmitting, by the control circuit to the mobile device, an indication of the delivery task for the product, wherein the indication of the delivery task for the product includes an augmented reality presentation of the product, and wherein the augmented reality presentation of the product is based on an item file in the database;
presenting, via a display device of the mobile device, the list, wherein the list includes a plurality of delivery tasks, wherein the plurality of delivery tasks includes the delivery task for the product;
receiving, via the user input device of the mobile device, selection of the delivery task for the product;
capturing, via a camera of the mobile device, an image of a cargo area of the user's vehicle;
generating, based on the image of the cargo area of the user's vehicle and the augmented reality presentation of the product, an augmented reality representation of the product within the cargo area of the user's vehicle, wherein the augmented reality representation of the product within the cargo area of the user's vehicle aids the user in determining whether the user can accommodate the product;
presenting, via the display device of the mobile device, the augmented reality representation of the product within the cargo area of the user's vehicle;
generating, by the control circuit in response to the selection of the delivery task for the product, an identifier, wherein the identifier indicates the user and the delivery task for the product; and
transmitting, by the control circuit to the mobile device, the identifier.

11. The method of claim 10, further comprising:
scanning, by a scanning device located at the one of the plurality of retail facilities, the identifier; and
receiving, by the control circuit, an indication that the identifier has been scanned by the scanning device.

12. The method of claim 10, further comprising:
capturing, by the camera of the mobile device, an image of a marker, wherein the image of the marker is used for scale in generating the augmented reality representation of the product within the cargo area of the vehicle.

13. The method of claim 10, wherein multiple of the plurality of distribution centers possess the product, the method further comprising:
selecting, by the control circuit from the multiple of the plurality of distribution centers, the one of the plurality of distribution centers.

14. The method of claim 13, wherein the selecting the one of the plurality of distribution centers is based on one or more of a location of each of the multiple of the distribution centers, a location of the user, a quantity of the product at each of the multiple distribution centers, planned shipments from each of the multiple distribution centers, and a location of the one of the plurality of retail facilities.

15. The method of claim 10, further comprising:
facilitating, by the control circuit, payment to the user.

16. The method of claim 15, wherein the facilitating the payment to the user is performed after receipt of confirmation that the delivery task for the product has been completed.

17. The method of claim 10, wherein the list of delivery tasks includes one or more of an indication of a product associated with each of the delivery tasks, a location of a distribution center, a location of a retail facility, a payment associated with each of the delivery tasks, and timing requirements associated with each of the delivery tasks.

18. The method of claim 10, wherein the registering the user includes a background check of the user.
